(19) United States
(12) Patent Application Publication
(10) Pub. No.: US 2004/0192386 A1
(43) Pub. Date: Sep. 30, 2004

(54) Method and apparatus for multiple subscriber identities in a mobile communication device

(76) Inventors: Naveen Aerrabotu, Gurnee, IL (US); Charles P. Binzel, Bristol, WI (US); Bharat Srinivasan, Arlington Heights, IL (US)

Correspondence Address: MOTOROLA INC, 600 NORTH US HIGHWAY 45, ROOM AS437, LIBERTYVILLE, IL, 60048-5343, US

(21) Appl. No.: 10/397,493

(22) Filed: Mar. 26, 2003

(51) Int. Cl. H04Q 7/20

(52) U.S. Cl. 455/558; 455/432.1

(57) ABSTRACT

A method and apparatus for multiple subscriber identities in a single subscriber module in a mobile communication device. The method can include storing the plurality of subscriber identities on the single mobile communication device subscriber module and personalizing the mobile communication device to each of the plurality of subscriber identities. The mobile communication device can issue a single command to retrieve all subscriber identities from the single mobile communication device subscriber module and store the plurality of subscriber identities from the single mobile communication device subscriber module to a memory of the mobile communication device. The plurality of subscriber identities can be stored in a single elementary file or another location on the single mobile communication device subscriber module.

### CROSS-REFERENCE TO RELATED APPLICATIONS

This application is related to the application entitled “Method and Apparatus for Updating a Subscriber Identity in a Mobile Communication Device,” Motorola case number CS22214RL, filed on even date herewith and commonly assigned to the assignee of the present application.

### BACKGROUND OF THE INVENTION

1. Field of Invention

The present invention is directed to a method and apparatus for multiple subscriber identities in a mobile communication device. In particular, the present invention is directed storing and accessing multiple subscriber identities on a subscriber module for a mobile communication device.

2. Description of Related Art

Presently a mobile communication device may be personalized to a particular security module for security purposes. Such a security module may be a Subscriber Identity Module (SIM), a User Services Identity Module (USIM), or any other security module. The security module can contain a single subscriber identity such as a code group, an International Mobile Subscriber identity (IMSI), or any other subscriber identity. The personalization is an anti-theft feature. When a mobile communication device is personalized to a particular security module, it can refuse to operate with another security module. Thus, if the mobile communication device is stolen, the thief cannot use the mobile communication device with another security module. While this does not prevent the mobile communication device from being stolen, it does make the mobile communication device less attractive to the thief.

The mobile communication device can be personalized by storing the single subscriber identity of the current subscriber module in the mobile communication device and setting a personalization indicator to “on.” Then, whenever a subscriber module is inserted or the mobile communication device is powered up with a subscriber module in place, the single subscriber identity is read from the subscriber module and checked against the stored subscriber identity. If there is no match, access to the mobile communication device functions is blocked and the mobile communication device may only allow emergency calls to be placed from the mobile communication device.

Unfortunately, typically a mobile communication device may only be personalized to a single subscriber identity. Also, a subscriber module for a mobile communication device cannot store easily accessible multiple subscriber identities. Additionally, a mobile communication device cannot easily access multiple subscriber identities on a single subscriber module. Furthermore, a mobile communication device cannot personalize to multiple subscriber identities on a single subscriber module. Thus, there is a need for a method and apparatus for multiple subscriber identities in a mobile communication device subscriber module.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a system according to a preferred embodiment;

FIG. 2 is an exemplary block diagram of a mobile communication device including a subscriber module according to a preferred embodiment;

FIG. 3 is an exemplary illustration of a mobile communication device subscriber module according to another embodiment;

FIG. 4 is an exemplary flowchart outlining the operation of a subscriber module and a mobile communication device according to a preferred embodiment;

FIG. 5 is an exemplary message sequence chart outlining the operation of a mobile communication device according to another embodiment;

FIG. 6 is an exemplary flowchart outlining the operation of the mobile communication device according to another embodiment; and

FIG. 7 is an exemplary message sequence chart outlining operation of the mobile communication device according to another embodiment.

### DETAILED DESCRIPTION OF PREFERRED EMBODIMENTS

The present disclosure provides an apparatus and method for updating a subscriber identity in a mobile communication device. For example, the present disclosure provides a method in a mobile communication device having a single mobile communication device subscriber module including a plurality of subscriber identities. The method can include storing the plurality of subscriber identities on the single mobile communication device subscriber module and personalizing the mobile communication device to each of the plurality of subscriber identities. The method can also include operating the mobile communication device on a first network using a first subscriber identity, detecting a change of network coverage to a second network, and switching an operational subscriber identity from the first subscriber identity to a second subscriber identity based on the change of network coverage. Detecting a change can include detecting a change from a first service cell to a second service cell. The first service cell may provide billing based on first subscriber and the second service cell may provide billing based on second subscriber.

Personalizing the mobile communication device can include issuing a select command to the single mobile communication device subscriber module, the select command selecting a subscriber identity elementary file on the single mobile communication device subscriber module, the subscriber identity elementary file containing the plurality of subscriber identities, sending a read command to the single mobile communication device subscriber module, receiving the plurality of subscriber identities from the single mobile communication device subscriber module in response to sending the read command, storing the plurality of subscriber identities in a memory of the mobile communication device, and setting a personalization indicator to on.

Personalizing the mobile communication device may also include reading a first subscriber identity from a subscriber identity elementary file, updating the subscriber identity elementary file with a second subscriber identity, and reading the second subscriber identity from the subscriber identity elementary file. Personalizing the mobile communication device may additionally include issuing a single command to retrieve all subscriber identities from the single mobile communication device subscriber module, storing the plurality of subscriber identities from the single mobile communication device subscriber module to a memory of the mobile communication device, and setting a personalization indicator to on.

The plurality of subscriber identities can be stored in a single elementary file or in other locations on the single mobile communication device subscriber module. The single mobile communication device subscriber module can be a Subscriber Identity Module and the subscriber identity can be an International Mobile Subscriber Identity.

According to another embodiment, the present disclosure can provide a method in a mobile communication device including a single subscriber module having a plurality of subscriber identities. The method can include issuing a select command to the single subscriber module, the select command selecting a subscriber identity elementary file on the single subscriber module, the subscriber identity elementary file containing the plurality of subscriber identities. The method can also include receiving a response from the subscriber module in response to issuing the select command, the response including a file size of the subscriber identity elementary file. The method can additionally include sending a read command to the single subscriber module and receiving the plurality of subscriber identities from the single subscriber module in response to sending the read command. The read command can include an offset parameter indicating an offset in the subscriber identity elementary file, and a length parameter indicating a length of the data to be read.

The method can further include storing the plurality of subscriber identities in a memory of the mobile communication device and setting a personalization indicator in the mobile communication device to on. The method can additionally include operating the mobile communication device on a first network using a first subscriber identity, detecting a change of network coverage to a second network, and switching an operational subscriber identity from the first subscriber identity to a second subscriber identity based on the change of network coverage, based on a location status message from the network, or any other service provider or card manufacturer algorithm.

The method can also include reading a subscriber identity from the single subscriber module, comparing the subscriber identity with the plurality of subscriber identities stored in the mobile communication device, and blocking use of selected features of the mobile communication device if the subscriber module subscriber identity does not match one of the plurality of subscriber identities stored in the mobile communication device. The subscriber module may be a Subscriber Identity Module and the subscriber identity may be an International Mobile Subscriber Identity.

According to another embodiment, the present disclosure can provide a mobile communication device subscriber module. The mobile communication device subscriber module can include a controller configured to control the operations of the mobile communication device subscriber module, an input and output contact point coupled to the controller, and a supply voltage contact point coupled to the controller. The mobile communication device subscriber module can also include a memory including a multiple subscriber identity elementary file. The multiple subscriber identity elementary file can have a body including a plurality of subscriber identity locations and a plurality of subscriber identities, each subscriber identity consisting of eight bytes. Each of the plurality of subscriber identity locations can include at least a subscriber identity of the plurality of subscriber identities. The multiple subscriber identity elementary file can include a mandatory first subscriber identity of eight bytes. The subscriber module can be a Subscriber Identity Module and the subscriber identity can be an International Mobile Subscriber Identity. The controller can be configured to operate the mobile communication device subscriber module on a first network using a first subscriber identity, detect a change of network coverage to a second network, and switch an operational subscriber identity from the first subscriber identity to a second subscriber identity based on the change of network coverage. The controller can also be configured to personalize a mobile communication device to the plurality of subscriber identities. The controller can be further configured to receive a select command from a mobile communication device, the select command selecting the multiple subscriber identity elementary file, accept a read command from the mobile communication device, and send the plurality of subscriber identities from the subscriber module in response to accepting the read command. The memory can also include a single subscriber identity elementary file comprising a body including a single subscriber identity.

According to another embodiment, the present disclosure can provide a method in a mobile communication device including a plurality of subscriber identities on a single mobile communication device subscriber module. The method can include storing the plurality of subscriber identities on the single mobile communication device subscriber module and issuing a retrieve command for retrieving all of the plurality of subscriber identities on the single mobile communication subscriber module. The method can also include receiving a subscriber identity amount indicator, the subscriber identity amount indicator indicating a number of subscriber identities located on the single mobile communication subscriber module. The method can additionally include receiving all of the plurality of subscriber identities from the single mobile communication subscriber module in response to sending the read command, and storing all of the plurality of subscriber identities to a memory of the mobile communication device. The method can further include personalizing the mobile communication device to each of the plurality of subscriber identities by setting a personalization indicator to on. The method can also include switching an operational subscriber identity from a first subscriber identity to a second subscriber identity. For example, the method can include operating the mobile communication device on a first network using a first subscriber identity, detecting a change of network coverage to a second network, and switching an operational subscriber identity from the first subscriber identity to a second subscriber identity based on the change of network coverage. The plurality of subscriber identities may be stored in a single elementary file or in any other location on the single mobile communication device subscriber module.

Among other benefits, the present invention can allow for storing and accessing multiple subscriber identities on a subscriber module for a mobile communication device. The present invention can additionally provide for personalizing a mobile communication device to multiple subscriber identities stored on a single subscriber module. The present invention can also provide for easily and readily accessing multiple subscriber identities on a single subscriber module. The present invention can further provide for an elementary file for storing multiple subscriber identities on a single subscriber module. The present invention can additionally provide for changing between multiple subscriber identities during operation of a mobile communication device. These and further benefits will become more apparent with reference to the Figures and the descriptions of the preferred embodiments.

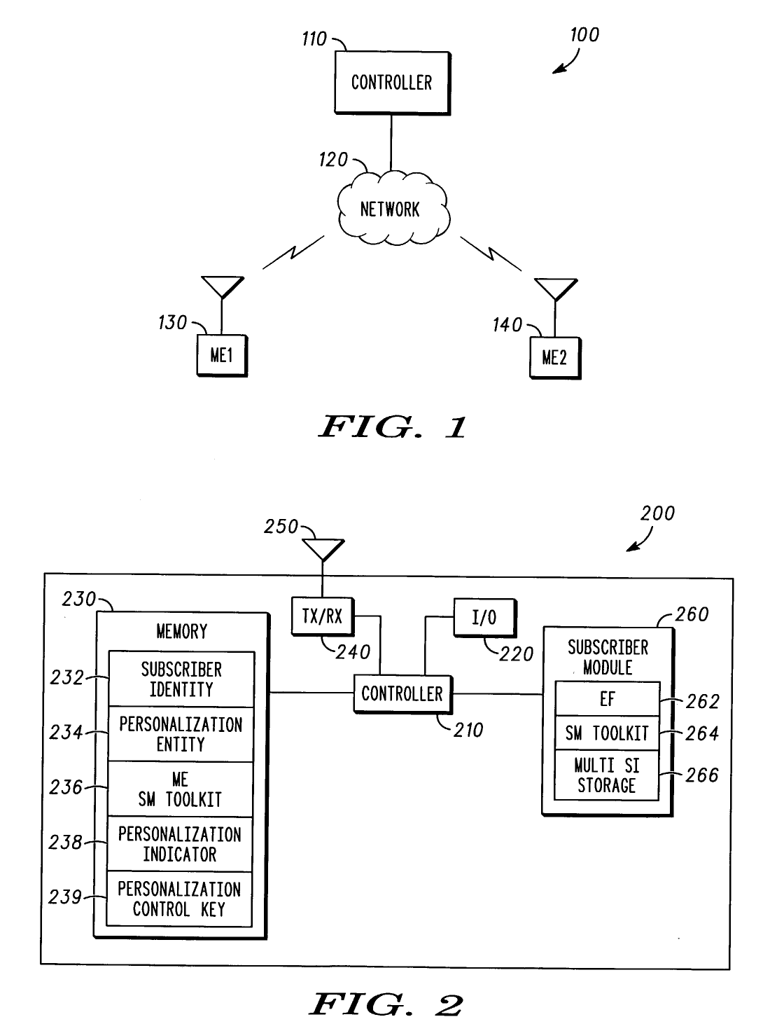

FIG. 1 is an exemplary block diagram of a system 100 according to a preferred embodiment. The system 100 can include a network controller 110, a network 120, and one or more mobile communication devices 130 and 140. The mobile communication devices 130 and 140 may be mobile equipment such as wireless telephones, cellular telephones, personal digital assistants, or any other devices that are capable of sending and receiving voice and data signals over a wireless network.

In an exemplary embodiment the network controller 110 is connected to the network 120. The network controller 110 may be included in a base transceiver station, a service center, or any other device on the network 120. The network 120 may include any type of network that is capable of sending and receiving communication signals. For example, the network 120 may include a data network, such as the Internet, an Intranet, a local area network (LAN), a wide area network (WAN), a cable network, and other like communication systems. The network 120 may also include a telecommunications network, such as a local telephone network, long distance telephone network, cellular telephone network, satellite communications network, cable television network and other like communications systems. Furthermore, the network 120 may include more than one network and may include a plurality of different types of networks. Thus, the network 120 may include a plurality of data networks, a plurality of telecommunications networks, a combination of data and telecommunications networks and other like communication systems. Preferably, the network 120 is a wireless network.

In operation, the network controller 110 can control operations on the network 120. The mobile communication devices 130 and 140 can transmit and receive wireless signals to and from the network 120. For example, the mobile communication device 130 can connect a voice call with the mobile communication device 140. Thus, users of the mobile communication devices 130 and 140 can audibly communicate with each other. Also, the mobile communication device 130 can connect a data call with the mobile communication device 140. Thus, users of the mobile communication devices 130 and 140 can send and receive data to and from each other and the network 120.

FIG. 2 is an exemplary block diagram of a mobile communication device 200, such as the mobile communication device 130, according to a preferred embodiment. The mobile communication device 200 can include a controller 210, input and output circuitry 220, a memory 230, a transceiver 240, an antenna 250 and a removable subscriber module 260. The subscriber module 260 may be a subscriber identity module such as a user services identity module, a removable user identity module, or any other subscriber module. The subscriber module 260 can include at least one elementary file 262, a subscriber module toolkit 264, and a multiple subscriber identity storage 266. The elementary file 262 can contain one subscriber identity. The multiple subscriber identity storage 266 may be a multiple subscriber identity elementary file, a hidden location for storing multiple subscriber identities, or any other storage location or locations for storing multiple subscriber identities. The subscriber module toolkit 264 can interact with the mobile communication device 200 to perform various functions with the mobile communication device 200.

The memory 230 may be a random access memory, a read only memory, an optical memory, or any other memory. The memory 230 can include subscriber identity storage 232, a personalization entity 234, a mobile equipment or mobile communication device subscriber module toolkit 236, a personalization indicator 238, and a personalization control key 239. The personalization entity 234 and the mobile communication device subscriber module toolkit 236 may also reside on the controller 210, as independent software or hardware modules, or in any other format on the mobile communication device 200. The subscriber identity storage 232 can contain a subscriber identity that the mobile communication device 200 is currently personalized to. The subscriber identity storage 232 may also contain a personalization list containing one or multiple subscriber identities. The personalization entity 234 can perform functions to personalize the mobile communication device 200 to a subscriber identity stored in the subscriber identity storage 232. The mobile communication device subscriber module toolkit 236 can control operations and communications with the subscriber module 260. The personalization indicator 238 can be set to “on” to indicate the mobile communication device 200 is personalized to a subscriber identity of a subscriber module. The personalization control key 239 controls the personalization of the mobile communication device 200. For example, the personalization control key 239 can be selected by a user to allow for de-personalization of the mobile communication device 200.

The transceiver 240 may include a transmitter and/or a receiver. The input and output circuitry 220 can include a microphone, a display, a speaker, a user input such as a keypad and buttons, or any other input and output circuitry.

In operation, the input and output circuitry 220 can accept various forms of input and output signals. For example, the input and output circuitry 220 can receive and output audio signals and data signals. The memory 230 can store data and software used in the mobile communication device 200. The transceiver 240 can transmit and/or receive data over a wireless network such as network 120. The controller 210 can control the operation of the mobile communication device 200.

When the mobile communication device 200 is personalized to a particular subscriber module or at least one subscriber identity, it can refuse to operate with any other subscriber modules or subscriber identities. The mobile communication device 200 can be personalized by storing at least one subscriber identity, such as a subscriber module code group, of the relevant subscriber module 260 in the subscriber identity storage 232 and setting the personalization indicator 238 to on. Whenever a subscriber module is inserted or the mobile communication device 200 is powered up with a subscriber module already in place, the at least one subscriber identity is read from the subscriber module and checked against the at least one subscriber identity stored in the subscriber identity storage 232. If there is no match, the mobile communication device 200 can go into an emergency calls only mode where only emergency calls can be placed from the mobile communication device 200.

As mentioned, the personalization control key 239 controls the personalization feature. This key can be selected by a user at personalization and can be later entered into the mobile communication device 200 to depersonalize the mobile communication device 200. The controller 210 can also support multiple instances of subscriber module personalization. For example, a subscribe identity can be read from a subscriber module and checked against a list of subscriber identities stored in the subscriber identity storage 232.

Personalizing the mobile communication device 200 may alternately include reading a first subscriber identity from the subscriber identity elementary file 262. The first subscriber identity can be stored in the memory 230. The subscriber identity elementary file 262 may then be updated with a second subscriber identity, for example, from the multiple subscriber identity storage 266. The second subscriber identity may then be read from the subscriber identity elementary file 262 and stored in the memory 230. The personalization indicator 238 may then be set to “on.”

A personalization check is performed whenever a subscriber module 260 is inserted into the mobile communication device 200 or whenever the mobile communication device 200 is powered up with a subscriber module 260 already in place. When more than one personalization is active in the mobile communication device 200, normal mode of operation can include performing any outstanding personalization checks. To perform a personalization check, the controller 210 first checks whether the mobile communication device 200 is personalized by checking the personalization indicator 238. If the personalization indicator 238 is set to “off,” the personalization check can be stopped and the mobile communication device 200 can go into normal mode of operation and omit the remaining steps of the check. If the personalization indicator 238 is set to “on,” the controller 210 continues the check. The controller 210 can then read the subscriber identity from the subscribe module 260. For example, the controller 210 can read the subscriber identity from the elementary file 262. The controller 210 can then perform the personalization check by checking the read subscriber identity against a subscriber identity or list of subscriber identities stored in the subscriber identity storage 232. If no match is found, the controller 210 can display an appropriate message on a display such as “Insert correct subscriber module” and can then go into an emergency calls only mode. Alternately, a user may be prompted to enter a special de-personalization code to de-personalize the mobile communication device 200 and allow for normal operation. Otherwise, if a match is found, the mobile communication device 200 can go into normal mode of operation.

According to a related embodiment, the personalization of a mobile communication device 200 results in the personalization control key 239 being set, the personalization indicator 238 being set to “on,” and the storage, in the subscriber identity storage 232, of at least one subscriber identity to which the mobile communication device 200 is personalized. To personalize the mobile communication device 200, first, the relevant subscriber identity is entered into the subscriber identity storage 232 either by reading the subscriber identity from the subscriber module 260, or by any other process such as one defined by a manufacturer. Second, the controller 210 can perform any necessary setup and necessary pre-personalization checks that may be useful for personalization. If the necessary checks are correct, the subscriber identity can be stored in the subscriber identity storage 232. If the checks fail, the personalization process can be terminated. Third, to personalize the mobile communication device 200 to more than one subscriber module, the above steps can be repeated. Fourth, the personalization control key 239 can be stored. A single personalization control key 239 can be used for both single and multiple subscriber module personalization. Finally, the personalization indicator 238 can be set to “on.”

To de-personalize the mobile communication device 200, the correct personalization control key 239 can be entered. The subscriber module 260 may or may not be present for de-personalization. If the subscriber module 260 is present, de-personalization may be offered regardless of whether any useful subscriber module personalization checks pass or fail. De-personalization can be provided by entry on a keypad of the input and output circuitry 220. Other de-personalization methods may be used. To de-personalize the mobile communication device 200, a user can, enter the personalization control key. If the entered personalization control key is the same as the one stored in the memory 230, the personalization indicator 238 is set to “off.” If the entered and stored personalization control key values differ, the de-personalization process can stop and the mobile communication device 200 can remain personalized.

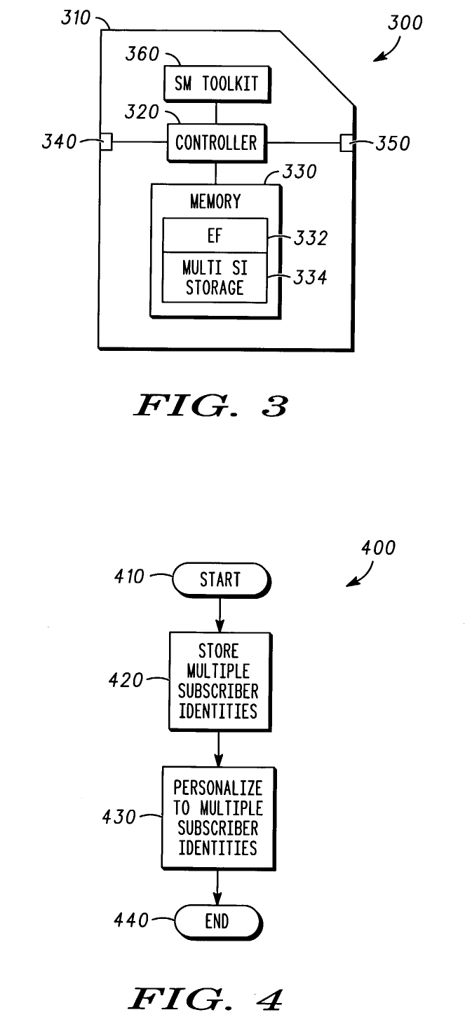

FIG. 3 is an exemplary illustration of a mobile communication device subscriber module 300 according to another embodiment. The subscriber module 300 can include a frame 310 and a subscriber module controller 320 configured to control the operations of the subscriber module 300. The subscriber module 300 can also include an input and output contact point 340 coupled to the subscriber module controller 320, a supply voltage contact point 350 coupled to the subscriber module controller 320, and a memory 330 coupled to the subscriber module controller 320. The input and output contract point 340 may include multiple contacts for sending and receiving communications. The memory 330 can include a multiple subscriber identity storage 334. The multiple subscriber identity storage 334 may be a multiple subscriber identity elementary file, a storage location, storage locations, or any other storage for multiple subscriber identities. For example, the multiple subscriber identity elementary file can include a body having a plurality of subscriber identity locations and a plurality of subscriber identities, each of the plurality of subscriber identity locations comprising at least a subscriber identity of the plurality of subscriber identities. The memory 330 can also include a single subscriber identity elementary file 332. The single subscriber identity elementary file 332 can have a body including a single subscriber identity. According to one embodiment, only the single subscriber identity elementary file 332 may be visible to applications on a mobile communication device. This may assist in preventing hackers from viewing or altering the contents of the multiple identity storage 334.

A subscriber identity may consist of eight bytes. Also, a multiple subscriber identity elementary file can include a mandatory first subscriber identity of eight bytes. The subscriber module 300 can be a Subscriber Identity Module and a subscriber identity can be an International Mobile Subscriber Identity.

The subscriber module controller 320 can be further configured to operate the mobile communication device subscriber module 300 on a first network using a first subscriber identity, detect a change of network coverage to a second network, and switch an operational subscriber identity from the first subscriber identity to a second subscriber identity based on the change of network coverage. The subscriber module controller 320 can also be configured to personalize a mobile communication device to the plurality of subscriber identities. The subscriber module controller 320 can additionally be configured to receive a select command from a mobile communication device, the select command selecting the multiple subscriber identity storage 334, accept a read command from a mobile communication device, and send the plurality of subscriber identities from the subscriber module 300 to the mobile communication device in response to accepting the read command.

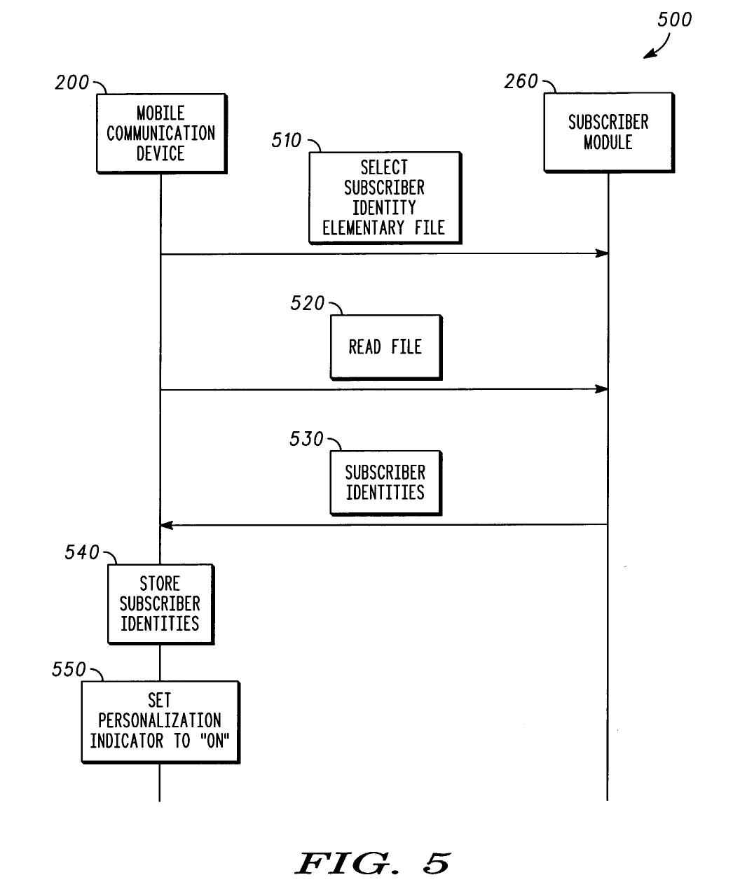

FIG. 4 is an exemplary flowchart 400 outlining the operation of a subscriber module 260 and a mobile communication device 200 according to a preferred embodiment. In step 410, the flowchart begins. In step 420, multiple subscriber identities are stored on the subscriber module 262. For example, multiple subscriber identities may be stored in an elementary file, or in any other useful location on the subscriber module 260. In step 430, the mobile communication device 200 is personalized to the multiple subscriber identities. In step 440, the flowchart ends.

FIG. 5 is an exemplary message sequence chart 500 outlining personalization of the mobile communication device 200 according to another embodiment. In step 510, the mobile communication device 200 can issue a select command to the single mobile communication device subscriber module 260. The select command can select a subscriber identity elementary file on the single mobile communication device subscriber module 260. The subscriber identity elementary file can contain the plurality of subscriber identities. The mobile communication device 200 may receive a response from the subscriber module 260 in response to issuing the select command. For example, the response can include a file size of the subscriber identity elementary file, a file identification of the subscriber identity elementary file, type of file information, access condition information, or any other useful information.

In step 520, the mobile communication device 200 can send a read command to the single mobile communication device subscriber module 260. The read command can include an offset parameter indicating an offset in an elementary file, and a length parameter indicating a length of the data to be read.

In step 530, the mobile communication device 200 can receive the plurality of subscriber identities from the single mobile communication device subscriber module 260 in response to sending the read command. In step 540, the mobile communication device 200 can store the plurality of subscriber identities in a memory 230 of the mobile communication device 200. In step 550, the mobile communication device 200 can set a personalization indicator 238 to “on.”

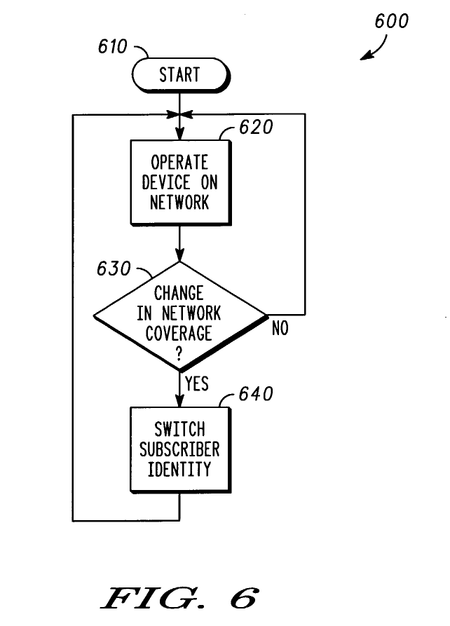

FIG. 6 is an exemplary flowchart 600 outlining the operation of the mobile communication device 200 according to another embodiment. In step 610, the flowchart begins. In step 620, the mobile communication device 200 operates on a network, such as network 120. For example, the network may be a local area network, a wide area network, a single cell of multiple cells in a network, or any other network. In step 630, the mobile communication device 200 can detect a change in network coverage to another network. For example, the mobile communication device 200 may move into another cell. As another example, the mobile communication device 200 may move from network coverage provided by one service provider to network coverage provided by another service provider. As another example, the mobile communication device 200 may switch modes of operation based on network coverage. As another example, the mobile communication device 200 may detect a position change using a positioning detection device such as a global positioning system device. As another example, the mobile communication device 200 may switch between networks that provide billing to different subscribers. For example, an employer may pay for mobile device service while an employee is at work, while the employee may pay for service elsewhere as determined by network coverage, a global positioning system device, or otherwise. If there is no change in network coverage, the mobile communication device 200 continues operation on the network in step 620. If there is a change in network coverage, in step 640 the subscriber module 260 on the mobile communication device 200 can switch an operational subscriber identity from an existing operational subscriber identity to another subscriber identity. Thus, the subscriber module 260 can change subscriber identities depending on network coverage. For example, the subscriber module 260 can keep the same subscriber identity in certain networks and change the subscriber identity for other networks.

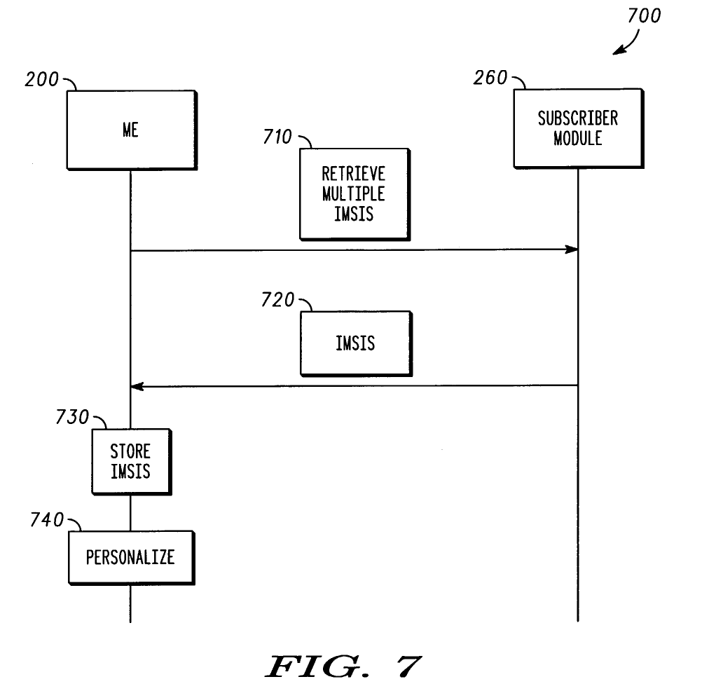

FIG. 7 is an exemplary message sequence chart 700 outlining operation of the mobile communication device 200 according to another embodiment. A plurality of subscriber identities may be stored on the subscriber module 260 in a single file or in any other locations. In step 710, a single multiple subscriber identity retrieve command can be issued to retrieve all subscriber identities from the single mobile communication device subscriber module 260. A subscriber identity amount indicator may be received from the subscriber module 260, the subscriber identity amount indicator indicating a number of subscriber identities located on the single mobile communication subscriber module. In step 720, the mobile communication device 200 can receive a plurality of subscriber identities from the subscriber module 260 in response to sending the read command. In step 730, the plurality of subscriber identities from the single mobile communication device subscriber module 260 can be stored 730 to a memory 230 of the mobile communication device 200. In step 740, if personalization is desired, a personalization indicator in the mobile communication device 200 can be set to “on.

After receiving all of the subscriber identities, the mobile communication device 200 can switch an operational subscriber identity from a first subscriber identity to a second subscriber identity. For example the mobile communication device can operate on a first network using a first subscriber identity, detect a change of network coverage to a second network, and switch an operational subscriber identity from the first subscriber identity to a second subscriber identity based on the change of network coverage.

The method of this invention is preferably implemented on a programmed processor. However, the network controller 110, the controller 210, and/or the subscriber module controller 320 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A method in a mobile communication device having a single mobile communication device subscriber module including a plurality of subscriber identities, comprising:
storing the plurality of subscriber identities on the single mobile communication device subscriber module; and
personalizing the mobile communication device to each of the plurality of subscriber identities.

2. The method according to claim 1, further comprising:
operating the mobile communication device on a first network using a first subscriber identity;
detecting a change of network coverage to a second network; and
switching an operational subscriber identity from the first subscriber identity to a second subscriber identity based on the change of network coverage.

3. The method according to claim 2, wherein detecting a change comprises detecting a change from a first service cell to a second service cell.

4. The method according to claim 3, wherein the first service cell provides billing based on first subscriber identity and the second service cell provides billing based on second subscriber identity.

5. The method according to claim 1, wherein personalizing the mobile communication device comprises:
issuing a select command to the single mobile communication device subscriber module, the select command selecting a subscriber identity elementary file on the single mobile communication device subscriber module, the subscriber identity elementary file containing the plurality of subscriber identities;
sending a read command to the single mobile communication device subscriber module;
receiving the plurality of subscriber identities from the single mobile communication device subscriber module in response to sending the read command;
storing the plurality of subscriber identities in a memory of the mobile communication device; and
setting a personalization indicator to on.

6. The method according to claim 1, wherein personalizing the mobile communication device comprises:
reading a first subscriber identity from a subscriber identity elementary file;
updating the subscriber identity elementary file with a second subscriber identity; and
reading the second subscriber identity from the subscriber identity elementary file.

7. The method according to claim 1, wherein personalizing the mobile communication device comprises:
issuing a single command to retrieve all subscriber identities from the single mobile communication device subscriber module;
storing the plurality of subscriber identities from the single mobile communication device subscriber module to a memory of the mobile communication device; and
setting a personalization indicator to on.

8. The method according to claim 1, wherein the plurality of subscriber identities are stored in a single elementary file on the single mobile communication device subscriber module.

9. The method according to claim 1, wherein the single mobile communication device subscriber module is a Subscriber Identity Module and the subscriber identity is an International Mobile Subscriber Identity.

10. A method in a mobile communication device including a single subscriber module having a plurality of subscriber identities, the method comprising:
issuing a select command to the single subscriber module, the select command selecting a subscriber identity elementary file on the single subscriber module, the subscriber identity elementary file containing the plurality of subscriber identities;
sending a read command to the single subscriber module;
receiving the plurality of subscriber identities from the single subscriber module in response to sending the read command;
storing the plurality of subscriber identities in a memory of the mobile communication device; and
setting a personalization indicator to on.

11. The method according to claim 10, further comprising:
operating the mobile communication device on a first network using a first subscriber identity;
detecting a change of network coverage to a second network; and
switching an operational subscriber identity from the first subscriber identity to a second subscriber identity based on the change of network coverage.

12. The method according to claim 10, further comprising receiving a response from the subscriber module in response to issuing the select command, the response including a file size of the subscriber identity elementary file

13. The method according to claim 10, wherein the read command includes an offset parameter indicating an offset in the subscriber identity elementary file, and a length parameter indicating a length of the data to be read.

14. The method according to claim 10, further comprising:
reading a subscriber identity from the single subscriber module;
comparing the subscriber identity with the plurality of subscriber identities stored in the mobile communication device; and
blocking use of selected features of the mobile communication device if the subscriber identity does not match one of the plurality of subscriber identities stored in the mobile communication device.

15. The method according to claim 10, wherein the subscriber module is a Subscriber Identity Module and the subscriber identity is an International Mobile Subscriber Identity.

16. A mobile communication device subscriber module comprising:
a controller configured to control the operations of the mobile communication device subscriber module;
an input and output contact point coupled to the controller;
a supply voltage contact point coupled to the controller;
a memory including a multiple subscriber identity elementary file, the multiple subscriber identity elementary file comprising a body including a plurality of subscriber identity locations and a plurality of subscriber identities, each of the plurality of subscriber identity locations comprising at least a subscriber identity of the plurality of subscriber identities, each subscriber identity consisting of eight bytes.

17. The mobile communication device subscriber module according to claim 16, wherein the multiple subscriber identity elementary file comprises a mandatory first subscriber identity of eight bytes.

18. The mobile communication device subscriber module according to claim 16, wherein the mobile communication device subscriber module is a Subscriber Identity Module and the subscriber identity is an International Mobile Subscriber Identity.

19. The mobile communication device subscriber module according to claim 16, wherein the controller is further configured to operate the mobile communication device subscriber module on a first network using a first subscriber identity;
detect a change of network coverage to a second network; and
switch an operational subscriber identity from the first subscriber identity to a second subscriber identity based on the change of network coverage.

20. The mobile communication device subscriber module according to claim 16, wherein the controller is further configured to personalize a mobile communication device to the plurality of subscriber identities.

21. The mobile communication device subscriber module according to claim 16, wherein the controller is further configured to
receive a select command from a mobile communication device, the select command selecting the multiple subscriber identity elementary file;
accept a read command from the mobile communication device; and
send the plurality of subscriber identities from the subscriber module in response to accepting the read command.

22. The mobile communication device subscriber module according to claim 16, wherein the memory further includes a single subscriber identity elementary file comprising a body including a single subscriber identity.

23. A method in a mobile communication device including a plurality of subscriber identities on a single mobile communication device subscriber module, comprising:
storing the plurality of subscriber identities on the single mobile communication device subscriber module;
issuing a retrieve command for retrieving all of the plurality of subscriber identities on the single mobile communication subscriber module;
receiving all of the plurality of subscriber identities from the single mobile communication subscriber module in response to sending the read command; and
storing all of the plurality of subscriber identities to a memory of the mobile communication device.

24. The method according to claim 23, further comprising receiving a subscriber identity amount indicator, the subscriber identity amount indicator indicating a number of subscriber identities located on the single mobile communication subscriber module.

25. The method according to claim 23, wherein the subscriber module is a Subscriber Identity Module and the subscriber identity is an International Mobile Subscriber Identity.

26. The method according to claim 23, further comprising switching an operational subscriber identity from a first subscriber identity to a second subscriber identity.

27. The method according to claim 23, further comprising:
operating the mobile communication device on a first network using a first subscriber identity;
detecting a change of network coverage to a second network; and
switching an operational subscriber identity from the first subscriber identity to a second subscriber identity based on the change of network coverage.

28. The method according to claim 23, further comprising personalizing the mobile communication device to each of the plurality of subscriber identities by setting a personalization indicator to on.

29. The method according to claim 23, wherein the plurality of subscriber identities are stored in a single elementary file on the single mobile communication device subscriber module.
